(19) United States
(12) Patent Application Publication
(10) Pub. No.: US 2010/0070643 A1
(43) Pub. Date: Mar. 18, 2010

(54) DELIVERY OF SYNCHRONIZED METADATA USING MULTIPLE TRANSACTIONS

(75) Inventors: Rajiv Puranik, Cupertino, CA (US); Ryan Cunningham, San Francisco, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/208,942

(22) Filed: Sep. 11, 2008

(51) Int. Cl. G06F 15/16; G06F 17/30

(52) U.S. Cl. 709/231; 707/E17.032

(57) ABSTRACT

Methods and apparatus are described relating to the delivery of synchronized metadata for use with an associated linear data stream, e.g., a video or audio stream. According to various embodiments of the invention, the metadata are delivered using multiple transactions.

### BACKGROUND OF THE INVENTION

The present invention relates to the delivery of synchronized metadata associated with streaming or streamable content.

Audio and video content streams often have associated synchronized metadata (i.e., data about data) relating to particular points in time or periods of time in the content stream. Such metadata might include, for example, annotations or tags (e.g., reviews, comments, feedback, ratings, etc.) which may be inserted by the author of the content, or by users listening to or watching the content stream. Subsequently, when another user experiences the content stream, the annotations and tags may be made visible to that user. Another type of synchronized metadata might relate to scene breaks, i.e., points in the content sequence which represent thematic breaking points. Yet another type of synchronized metadata is closed-captioning data for providing subtitles to a video stream. Still another form of synchronized metadata may identify the type or nature of content in an associated segment of the content stream. Various types of synchronized metadata may also be represented by mechanisms which allow a user to navigate to the point or segment in the content stream to which the metadata relates, e.g., links, as well as links to external URLs, e.g., relevant content external to the content stream.

Synchronized metadata associated with streaming content are typically delivered in one of two ways. In-stream delivery involves integrating the metadata in some fashion with the content stream itself. The most common examples of this approach are full-length motion pictures such as those encoded using one of the mpeg standards, e.g., mpeg21. Alternatively, synchronized metadata may be provided to the client using out-of-band delivery.

One problem with conventional in-stream delivery is that the metadata are fixed and format specific, and may not typically be updated without re-encoding new metadata with the content. This is particularly disadvantageous in the evolving context of online video delivery (e.g., Yahoo! Video, YouTube, etc.) in which the metadata associated with the videos being delivered are constantly being modified and added to by users.

By contrast, out-of-band delivery is generally format neutral and allows for a more flexible approach to the addition or modification of metadata. However, depending on the length of the content (e.g., a long video), out-of-band delivery may result in unacceptable delays in delivery of the content itself, or in unacceptably large amounts of metadata being stored on the client.

### SUMMARY OF THE INVENTION

According to the present invention, synchronized metadata associated with data streams are delivered out-of-band using multiple transactions. According to one class of embodiments, methods and apparatus are provided for delivering synchronized metadata associated with a content data stream to a client system for presentation in conjunction with presentation of content represented by the content data stream. The synchronized metadata are transmitted in a plurality of metadata segments using a separate transaction for each metadata segment. Each metadata segment corresponds to a particular time segment of the content data stream.

According to another class of embodiments, a computer program product is provided comprising at least one computer-readable medium having computer program instructions stored therein which, when executed by a computing device, cause the computing device to generate a representation of content from a content data stream, and to present representations of synchronized metadata in conjunction with the representation of the content. The computer program instructions are further configured to cause the computing device to request the synchronized metadata to be delivered in a plurality of metadata segments using a separate transaction for each metadata segment. Each metadata segment corresponds to a particular time segment of the content data stream.

A further understanding of the nature and advantages of the present invention may be realized by reference to the remaining portions of the specification and the drawings.

### BRIEF DESCRIPTION OF THE DRAWINGS

FIG. 1 is a simplified system diagram illustrating operation of a system implemented according to a specific embodiment of the invention.

FIG. 2 is a flowchart illustrating operation of the system of FIG. 1.

FIG. 3 is a depiction of a timeline of a video to illustrate aspects of an embodiment of the present invention.

FIG. 4 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention use multiple transactions to deliver synchronized metadata for use with an associated linear data stream, e.g., a video or audio stream. As will be described, the metadata may be segmented in a variety of ways (e.g., by time, data volume, etc.). According to some embodiments, the segmentation is done with reference to the density and/or distribution of the metadata along a timeline associated with the content stream. According to various embodiments, the metadata may be delivered to client devices in accordance with patterns of consumption of the content as well as in accordance with the capabilities of the client devices themselves. Some examples of particular implementations are discussed below.

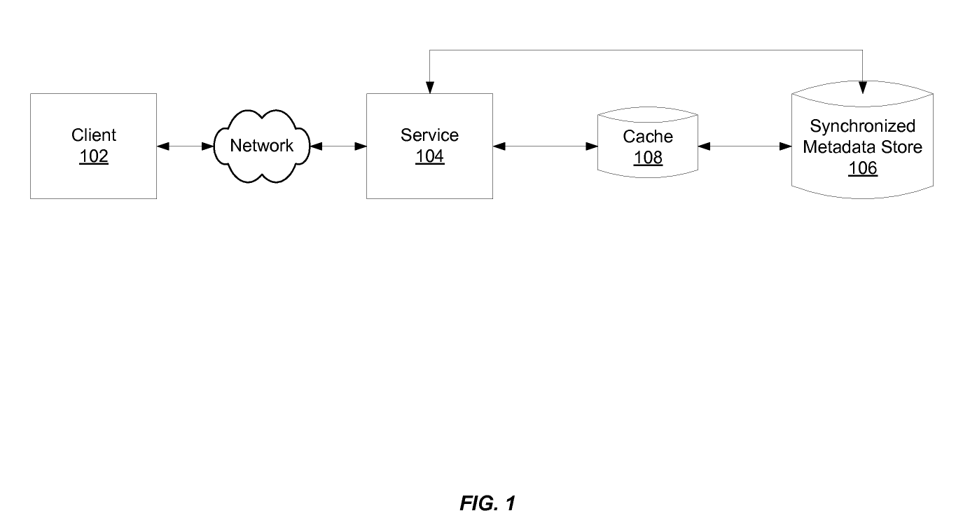

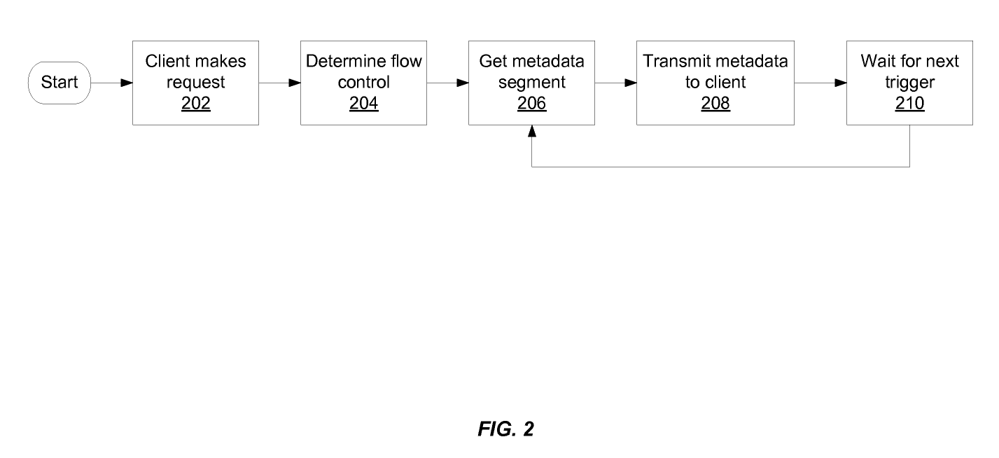

FIG. 1 is a simplified system diagram and FIG. 2 is a flowchart illustrating the delivery of synchronized metadata according to a specific embodiment of the invention. In this example, the type of content is assumed to be video. However, it will be understood that embodiments of the invention may be applied to other types of content delivered or deliverable continuously on a timescale (linear or otherwise), e.g., audio, as well as a wide variety of formats of any particular type of content. In the system shown, a client 102 connects with and requests video content from a content delivery service 104. Content delivery service 104 may be, for example, any online video delivery service such as, for example, Yahoo! Video, or Google's YouTube. Client 102 may include any of a wide variety of stand-alone media players as well as media players embedded in a browser application. The following discussion will refer generically to the client 102, but it will be understood that the reference may include the media player as well as other applications or code operating on the client including portions of the client operating system.

In conjunction with a request (202) from a client 102 (e.g., from a media player on the client) to a content delivery service 104 to initiate content playback, a flow control determination (204) is made regarding the nature of and relationship between the multiple transactions by which the synchronized metadata associated with the requested content are to be delivered. This determination may be based on the density and/or distribution of metadata on the content timeline (described in greater detail below), as well as the capabilities of the requesting client. That is, for example, the processing capabilities and/or available memory of the client may be used to determine how often and/or what amount of metadata are to be delivered. So, for example, because a cell phone's capabilities are radically different than those of a desktop computer or a set-top box, the flow control applied to each would be appropriate for the corresponding device capabilities.

According to a specific embodiment, the flow control determination may be specified by the client itself. That is, for example, the media player with which the requested content is to be played may specify an interval between transactions, a volume of metadata for each transaction, etc. According to one embodiment, the flow control determination may be made with reference to a simple table which associates available bandwidth (statically set or determined using various dynamic mechanisms) with different volumes of metadata.

Alternatively, the back-end service may make the determination. In such embodiments, the necessary parameters required for making this determination may be embedded in or associated with the initial request from the client, may be requested by the back-end service in response to the request, or be already available to the back-end service in an associated data store (e.g., as part of user or device registration information).

According to various embodiments, flow control may effected in a variety of ways including, for example, a purely time based approach, based on the volume of data being delivered, based on the number or a count of metadata items, or any combination of any of these. For example, the flow control determination could be that synchronized metadata are to be delivered for each 15-second segment of a video. In another example, the flow control determination could be that the metadata are to be delivered in 50-kilobyte “chunks” which may correspond to video segments of arbitrary length. In yet another example, the flow control could be based on both time and the amount of metadata, e.g., delivery of 10 items of metadata or within 15 seconds, whichever occurs first. The term “metadata segment” will be used herein to refer generically to a set of synchronized metadata segmented according to any of the approaches described herein. Various alternatives and combinations will be apparent to those of skill in the art.

Flow control may also be influenced by filters which specify that only certain types of metadata are desired or may be displayed. These filters might be set with reference to the capabilities of the requesting client. For example, metadata requiring extensive processing or memory resources might be excluded where the requesting client is a handheld device. These filters might also be set with input from the user regarding the nature of metadata that user wishes to experience. For example, a user might specify that he only wishes to see tag or annotations. In addition, a user might specify that she only wishes to see metadata generated by people she knows (e.g., as determined from a contact or buddy list). Filters might also be set with reference to client capabilities, e.g., if a client can't support subtitles, the corresponding metadata may be filtered out. In another example, if the client doesn't have a web browser, URLs may be filtered out.

Once the flow control determination is made, the back-end service 104 retrieves the appropriate segment of the synchronized metadata (206) either from a synchronized metadata store 106 or from a synchronized metadata cache 108. That is, according to specific embodiments of the invention, synchronized metadata may be cached closer to each server responding to metadata requests to enable the server to respond more efficiently. The server would first determine whether the requested metadata were in the cache before requesting them from metadata store 106. If not, it would retrieve the metadata from store 106 and cache them in cache 108 for later use. According to some embodiments, one or more metadata segments subsequent to the current segment being delivered may be cached prior to being requested in anticipation of the likelihood that such segment(s) will soon be required. Such an a priori caching would be particularly useful in situations in which a user is experiencing the content in one continuous flow rather than jumping around. It should be noted that, where practical, the client may also implement a local cache of synchronized metadata in anticipation of future requests for the same content or section of a content stream.

The metadata segment is then transmitted to the client (208). According to a particular implementation, additional information is transmitted with the metadata segment (e.g., in xml format) to identify for the client when the client should request the next metadata segment. For example, such information might include a time range in the content timeline to which the transmitted metadata segment corresponds so that the client can determine when the metadata in the segment are nearly exhausted. Alternatively, a time stamp might be included corresponding to a point in the content timeline at which the next metadata segment should be requested. Other variations are contemplated which should be apparent to those of skill in the art.

Content delivery service 104 then waits for the next trigger (210), e.g., as determined by the flow control, to deliver further synchronized metadata (206). This may occur in different ways depending on the particular implementation. In one class of embodiments, the client 102 tracks its own progress through the video timeline and, when it determines that it needs more metadata (e.g., because the transaction interval is nearly complete), it sends a request for the next metadata segment to content delivery service 104. The request (e.g., an http request) may include, for example, a start time or time range in the video timeline so that the corresponding metadata segment can be identified by the back end. In another class of embodiments, service 104 could track the parameter(s) necessary to identify the next trigger.

It will be understood that the former approach may be preferred where, as with many applications, the connection between the client and the server is not persistent. In such situations, the client needs to be tracking when the next metadata segment is required. This is particularly true for content like video in which users are able to jump around to different points, pause, fast forward, rewind, etc.

On the other hand, embodiments are contemplated in which synchronized metadata segments are regularly transmitted to the client regardless of the user's progress through the content. For example, if the flow control determination is such that a transaction interval of 20 seconds is selected, one approach would be to automatically transmit successive metadata segments to the client every 20 seconds without requiring requests from the client or any particular type of interaction by the user with the content. Such an approach might be advantageous where, for example, the intent is to eventually have all of the synchronized metadata for a given piece of content available on the client. According to one embodiment, where it is determined (either by the client or the server) that the user has paused the content or that the entirety of the content has been downloaded to the client, advantage may be taken of the newly available transmission bandwidth by delivering all or some larger portion of the remaining synchronized metadata. Yet another embodiment is contemplated where a request for all remaining metadata may be initiated by the user, e.g., using a control provided in the user interface.

From the foregoing description, it should be appreciated that extremely flexible approaches to synchronized metadata delivery are enabled by embodiments of the present invention. For example, if the user watching a video decides to jump ahead to another point in the video for which the synchronized metadata have not yet been delivered, this may be treated as a trigger for fetching the required metadata segment as described above. And because the amount of metadata delivered is relatively small and appropriate for the capabilities of the requesting device, this may be done in a seamless manner.

In addition, because only relatively small portions of synchronized metadata are consumed by the client at any given time, it is possible to deliver newly generated synchronized metadata in near real time, i.e., while a user is watching a video. That is, for example, suppose two users are watching the same video with a first one of the users being ahead of the second user in the video timeline. If the first user enters an annotation at a point in the video timeline ahead of the point at which the second user is currently watching, when the second user's client requests the synchronized metadata segment corresponding to the that point in the video, the segment may already include the first user's annotation. As will be understood, this is not possible with conventional approaches to the delivery of synchronized metadata.

According to some embodiments, the client may initiate a synchronized metadata cleanup to discard metadata that is old or no longer relevant to the current position on the content timeline. For example, metadata outside of a 5 minute time window of the current timeline position could be discarded to save memory space. Alternatively, the client could apply other approaches to discarding metadata such as, for example, a “least recently used” approach.

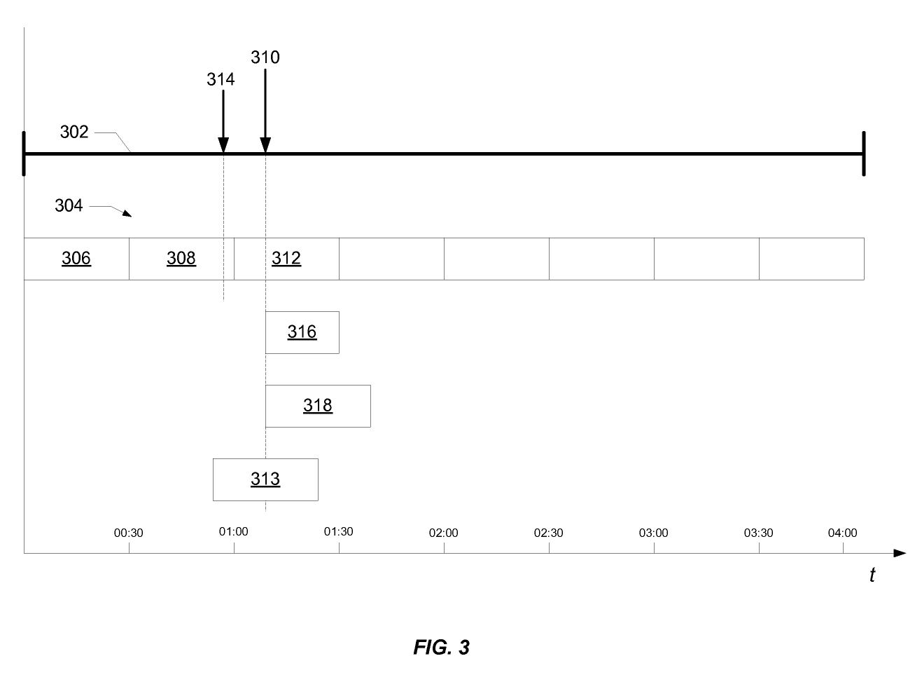

FIG. 3 is a representation of a timeline 302 of a video to illustrate aspects of an embodiment of the present invention. Below timeline 302 is a representation of the synchronized metadata 304 in which the metadata are broken up into 30-second segments, i.e., each metadata segment includes metadata associated with a 30-second segment of video 302. When the video playback is initiated, the first 30-second segment of metadata (306), is delivered to the client. If the playback is continuous, the next segment (308) is delivered to the client slightly before the end of the video segment for the current metadata. As discussed above, this might be effected by a request from the client to the content delivery service, or on the initiative of the content delivery service itself.

If the user watching the video decides to jump ahead to a subsequent point in the video playback, e.g., point 310, this is treated as a trigger event which precipitates the delivery of the synchronized metadata associated with point 310. According to some embodiments, this may be metadata segment 312 as determined with reference to the original flow control determination even though this segment includes metadata which may relate to a segment of the video preceding point 310. This approach could be advantageous with regard to the caching of metadata in that the metadata segments being cached would, at least to some degree, be more predictable and uniform across users.

However, such an approach could also lead to some interesting corner cases. One example is a case in which the point to which the user jumps is right before a 30-second segment boundary, e.g., point 314. That is, metadata segment 308 which includes point 314 will need to be delivered, but the need for delivery of metadata segment 312 may also have arisen. In such a case, a decision could be made to deliver both of metadata segments 308 and 312 in a single transaction, or in 2 successive, closely-spaced transactions. The rules by which such a decision could be made may be implemented in the client or at the back-end service.

Alternatively, the synchronized metadata being delivered could be determined with reference to point 310. That is, for example, the metadata to be delivered may be determined with reference to a “window” around point 310 as illustrated by metadata segment 313. In another example, only the metadata in metadata segment 312 relating to video occurring on or after point 310 might be delivered (as illustrated by metadata segment 316). In yet another example, the metadata associated with the 30-second video segment beginning at point 310 might be delivered (as illustrated by metadata segment 318). It should be noted that, in the latter two examples, at least some of the metadata in metadata segments 316 and 318 may correspond to points on video timeline 302 slightly before or after point 310, i.e., the metadata don't need to correspond exactly to point 310. Other variations are contemplated and will be appreciated by those of skill in the art.

Defining the synchronized metadata segment to be delivered with reference to a point like point 310 may also have advantages with regard to caching in the case where point 310 becomes a popular point in the content. For example, if point 310 corresponds to a tag entered by a user to identify his favorite point in a video, and that user shares links to point 310 with a large social network, the set of synchronized metadata defined by point 310 then has the potential for becoming a frequently used metadata segment, and therefore an excellent candidate for caching.

According to some embodiments of the invention, a global or summary view of the synchronized metadata (i.e., meta-metadata) associated with the whole or a larger portion of the content may also be delivered (e.g., when playback is initiated) so that the user is able to see whether there might be something of interest in the content beyond the first segment of the content. For example, a user may have specified that she would like to see all annotations of a video entered by a particular friend so that she can jump to those portions of the video. Some indication of the locations of these annotations (e.g., links) could then be provided on a representation of the video timeline to enable such navigation. Such a global metadata summary or profile might also identify things like scene breaks, most popular segments, etc. Thus, in addition to the segmented delivery of synchronized metadata described herein, it is also possible to deliver synchronized metadata using a tiered or hierarchical approach in which the different tiers or levels of the hierarchy represent different ranges, levels of abstraction, or filtering of the underlying synchronized metadata.

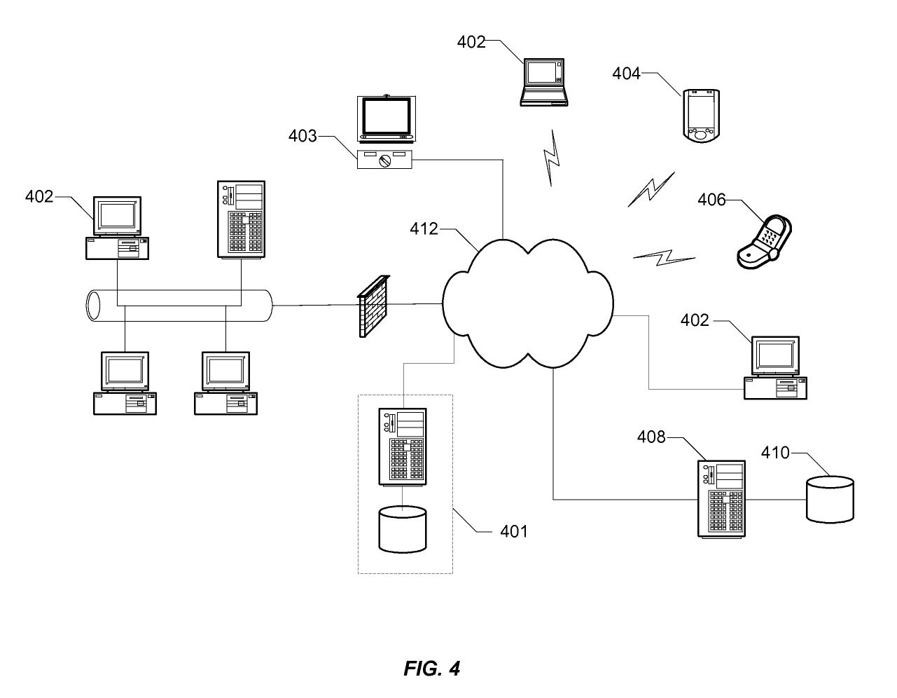

Embodiments of the present invention may be employed to deliver synchronized metadata associated with content streams in any of a wide variety of computing contexts. For example, as illustrated in FIG. 4, implementations are contemplated in which a population of users interacts with content providers (e.g., web sites 401) via a diverse network environment using any type of computer (e.g., desktop, laptop, tablet, etc.) 402, media computing platforms 403 (e.g., cable and satellite set top boxes and digital video recorders), handheld computing devices (e.g., PDAs) 404, cell phones 406, or any other type of computing or communication platform. As will be understood, delivery of metadata for presentation in conjunction with content may be optimized in accordance with the invention for presentation on any device or display type via any type of delivery channel.

The delivery of content and associated synchronized metadata according to the invention may be effected in a centralized manner. This is represented in FIG. 4 by server 408 and data store 410 which, as will be understood, may correspond to multiple distributed devices and data stores. Alternatively, the delivery of content and associated metadata according to the invention may be effected in a distributed manner, e.g., with the content and the metadata being delivered from different sites. The invention may also be practiced in a wide variety of network environments including, for example, TCP/IP-based networks, telecommunications networks, wireless networks, etc. These networks are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described herein primarily with reference to applications relating to the delivery of streaming media such as video and audio. First, it should be understood that the present invention is not limited to specific content delivery services, format, or protocols. Rather, the principles of the invention may be applied to any content delivery application in which segmented, out-of-band delivery of metadata is useful.

In addition, the present invention is not necessarily limited to applications for delivering streaming content such video or audio. Rather, implementations of the present invention are contemplated in which the sequential or linear transmission of any type of data having associated synchronized metadata may be enhanced. For example, the present invention may be applied to a variety of streaming content, e.g., news headlines, sports scores, weather reports, etc. Moreover, embodiments of the present invention may be particularly advantageous for streaming applications which have some associated high processing overhead (e.g., encryption and/or compression). In such cases, having metadata delivered out-of-band may reduce some of the processing overhead. In one example, an encrypted document may be delivered as a stream, either because of bandwidth constraints (e.g., as preferred or required for a resource-limited client), or for security purposes (e.g., to prevent the client from storing copies of the document). In such a case, any metadata associated with various portions of the document could be delivered in accordance with embodiments of the invention.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for delivering synchronized metadata associated with a content data stream to a client system for presentation in conjunction with presentation of content represented by the content data stream, method comprising transmitting the synchronized metadata in a plurality of metadata segments using a separate transaction for each metadata segment, each metadata segment corresponding to a particular time segment of the content data stream.

2. The method of claim 1 further comprising determining a transmission interval to govern transmission of metadata segments, the transmission interval relating to one or both of a distribution of the synchronized metadata along a timeline associated with the content data stream, or a capability of the client device.

3. The method of claim 2 wherein the transmission interval comprises a period of time or a volume of metadata.

4. The method of claim 2 wherein determining the transmission interval is also done with reference to at least one filter configured to selectively exclude portions of the synchronized metadata from the metadata segments.

5. The method of claim 2 wherein the transmission interval is specified by the client device.

6. The method of claim 2 further comprising transmitting temporal information in conjunction with each of the metadata segments relating the metadata segment to the timeline.

7. The method of claim 1 further comprising caching at least some of the metadata segments for future retrieval.

8. The method of claim 1 wherein transmission of each successive metadata segment is precipitated by a trigger event.

9. The method of claim 8 wherein the trigger event comprises a request from the client device for a specific one of the metadata segments.

10. The method of claim 9 wherein the request specifies a point in time on a timeline associated with the content data stream, and wherein the specific one of the metadata segments comprises one of the group consisting of a predetermined metadata segment corresponding to the point in time, a remainder of the predetermined metadata segment determined with reference to the point in time, or a newly determined metadata segment derived with reference to the point in time.

11. A system for transmitting a content data stream to a client device for presentation of content represented by the content data stream, the system comprising at least one computing device configured to transmit synchronized metadata associated with the content data stream in a plurality of metadata segments using a separate transaction for each metadata segment, each metadata segment corresponding to a particular time segment of the content data stream.

12. The system of claim 11 wherein the at least one computing device is further configured to determine a transmission interval to govern transmission of metadata segments, the transmission interval relating to one or both of a distribution of the synchronized metadata along a timeline associated with the content data stream, or a capability of the client device.

13. The system of claim 12 wherein the transmission interval comprises a period of time or a volume of metadata.

14. The system of claim 12 wherein the at least one computing device is further configured to determine the transmission interval with reference to at least one filter configured to selectively exclude portions of the synchronized metadata from the metadata segments.

15. The system of claim 12 wherein the transmission interval is specified by the client device.

16. The system of claim 12 wherein the at least one computing device is further configured to transmit temporal information in conjunction with each of the metadata segments relating the metadata segment to the timeline.

17. The system of claim 11 wherein the at least one computing device is further configured to cache at least some of the metadata segments for future retrieval.

18. The system of claim 11 wherein the at least one computing device is configured to transmit each successive metadata segment in response to a trigger event.

19. The system of claim 18 wherein the trigger event comprises a request from the client device for a specific one of the metadata segments.

20. The system of claim 19 wherein the request specifies a point in time on a timeline associated with the content data stream, and wherein the specific one of the metadata segments comprises one of the group consisting of a predetermined metadata segment corresponding to the point in time, a remainder of the predetermined metadata segment determined with reference to the point in time, or a newly determined metadata segment derived with reference to the point in time.

21. A computer program product comprising at least one computer-readable medium having computer program instructions stored therein which, when executed by a computing device, cause the computing device to generate a representation of content from a content data stream, and to present representations of synchronized metadata in conjunction with the representation of the content, the computer program instructions being further configured to cause the computing device to request the synchronized metadata to be delivered in a plurality of metadata segments using a separate transaction for each metadata segment, each metadata segment corresponding to a particular time segment of the content data stream.

22. The computer program product of claim 21 wherein the computer program instructions are further configured to cause the computing device to determine a transmission interval to govern transmission of metadata segments, the transmission interval relating to one or both of a distribution of the synchronized metadata along a timeline associated with the content data stream, or a capability of the computing device.

23. The computer program product of claim 22 wherein the transmission interval comprises a period of time or a volume of metadata.

24. The computer program product of claim 22 wherein the computer program instructions are further configured to cause the computing device to determine the transmission interval with reference to at least one filter configured to selectively exclude portions of the synchronized metadata from the metadata segments.

25. The computer program product of claim 21 wherein the computer program instructions are further configured to cause the computing device to generate a metadata request for each required metadata segment, wherein each request specifies a point in time on a timeline associated with the content data stream, and wherein the required metadata segment comprises one of the group consisting of a predetermined metadata segment corresponding to the point in time, a remainder of the predetermined metadata segment determined with reference to the point in time, or a newly determined metadata segment derived with reference to the point in time.
